(19) United States
(12) Patent Application Publication
(10) Pub. No.: US 2015/0263983 A1
(43) Pub. Date: Sep. 17, 2015

(54) System and Method for Allocating Resources and Managing a Cloud Based Computer System

(71) Applicant: Stratus Technologies Bermuda Ltd., Hamilton (BM)

(72) Inventors: Ed Brennan, Scituate, MA (US); Nicole Reineke, Northborough, MA (US); Keith Meyer, Southborough, MA (US); Kate Coyne, Watertown, MA (US); Jeff Dutton, Newton, MA (US); Jay Janardhan, Billerica, MA (US); Jim Orander, East Wareham, MA (US); Aaron Smith, Sudbury, MA (US)

(21) Appl. No.: 14/584,253

(22) Filed: Dec. 29, 2014

Related U.S. Application Data
(60) Provisional application No. 61/921,814, filed on Dec. 30, 2013.
(60) Provisional application No. 62/052,130, filed on Sep. 18, 2014.

(51) Int. Cl. H04L 12/911; H04L 29/08

(52) U.S. Cl. CPC H04L 47/70; H04L 67/10

(57) ABSTRACT

A method of provisioning a computer application in a cloud environment having hardware. In one embodiment, the method includes the steps of: providing the computer application; defining the processing requirements of the computer application; defining the storage requirements of the computer application; defining the network requirements of the computer application; defining the policies for the computer application; defining a Container comprising the computer application, the processing requirements of the computer application, the storage requirements of the computer application, the network requirements of the computer application; and selecting cloud hardware in response to the components of the Container.

### RELATED APPLICATIONS

This application claims priority to U.S. provisional patent application 61/921,814 filed on Dec. 30, 2013 and U.S. provisional patent application 62/052,130 filed Sep. 18, 2014, both of which are owned by the assignee of the current application, the contents of both of which are hereby incorporated by reference in their entireties.

### FIELD OF THE INVENTION

The invention relates generally to cloud based computing, and more specifically to systems and methods of associating hardware and software components and attributes, including high availability attributes and compliance attributes.

### BACKGROUND OF THE INVENTION

Cloud based computing, according to the National Institute of Standards and Technology (NIST) (see NIST Publication 800-145), is a system model for enabling convenient, on-demand network access to a shared group of configurable computing resources such as, but not limited to, servers, storage, and applications, that can be rapidly provided to a user and released by the user with minimal effort by system management and service providers. According to NIST, this cloud model has five characteristics.

The five characteristics are:
On-demand self-service. A user can unilaterally and automatically obtain cloud resources, such as processor or server time and data storage, when the user requires it without requiring human interaction with service providers.
Broad network access. The cloud resources are available directly over the network and are accessed through standard network functions that allow access by heterogeneous thin or thick client platforms such as, but not limited to, smart phones, tablets, etc.
Resource sharing. The cloud's resources are pooled to serve multiple users with different physical and virtual resources dynamically assigned and reassigned according to user demand. This pooling is location independent, such that the customer generally has no control or knowledge over the geographic location of the resources. In some cases, the user may be able to specify the location of the resource at a high granularity, such as requiring that the resource be located within a specified country.
Rapid elasticity. Each resource may be provisioned and released to scale the provisioning of the resource with user demand, such that the resource appears to the user as unlimited and available at any time.
Measured service. Cloud systems control and optimize resource use by metering the type of service. In this way, resource usage can be monitored, controlled, and reported.

Such clouds may be: private, belonging to a single organization and accessible only by members of that organization; community based, such that their users come from multiple organizations having shared goals; public, available to the general public; and hybrid, which is a combination of two or more of the private, community based or public clouds. These clouds are generally used to provide: Software as a Service (SaaS), in which applications are provided by the cloud; Platform as a Service (PaaS) in which user applications from outside the cloud utilize the cloud resource but the user has no control over the platform; and Infrastructure as a Service (IaaS) in which users may utilize and control cloud-provided operating systems and storage to run the user's applications.

Because the cloud's location of resources is generally irrelevant to the user, cloud based applications may be moved from one location to another or from one resource to another transparently, without the user becoming aware. This may be necessary for maintenance, cloud platform expansion or disaster recovery. As such, it is necessary that each application be associated with the hardware, software and attributes it needs to be managed on an individual basis such that those requirements may be moved or replaced without reducing the availability of the application to a user. This process is time consuming and can lead to errors when individual computing resources are not properly allocated.

The present invention addresses these needs.

### SUMMARY OF THE INVENTION

In one aspect, the invention relates to a method of provisioning a computer application in a cloud environment built on a hardware infrastructure. In one embodiment, the method includes the steps of: providing the computer application (which may be comprised of one or more individual applications, virtual machines, or physical machines); defining the processing requirements of the computer application; defining the storage requirements of the computer application; defining the network requirements of the computer application; defining the policies for the computer application; defining the processing requirements of the computer application, the storage requirements of the computer application, and the policies for the computer application (such as business requirements, security requirements, etc.); combining a superset of the requirements into a Container definition that comprises the computer application and selecting cloud hardware in response to the components of the Container.

In one embodiment, a Container refers to a collection of hardware, software and attributes within which some information technology function is performed. In yet another embodiment, the Container is a collection of descriptors (known as a Deployment Package) that describes the interrelationships among each component of a software application and their relationships to resources outside of the cloud. Related to these various descriptors are “Tags” which describe the desired behavior of each component when consuming resources in the cloud.

In one embodiment, the Deployment Package establishes the application requirements including Images, Volumes, Internal Network Interdependencies, External Network Interdependencies, and security requirements. In another embodiment, Tags describe desired behaviors when consuming cloud resources such as: availability level (strategy to implement), performance level, types of hypervisors to consume, types of storage to consume, types of monitoring to utilize, physical location, and recovery mode (desired behavior for failure recovery).

In yet another embodiment, once an application is deployed, Tags may be manipulated to alter behaviors of components of the application, either permanently or according to a schedule. For example, a requirement that a given Container be required to provide high availability for the computing resources that, at least partially, define the Container can be accomplished by assigning a High Availability Tag to the Container. If high availability is only required for a period of time, a user may schedule such a Tag to be changed in the future, altering the behavior of the application at that time. Upon a change to a Tag (user manipulated or scheduled), a control system termed an “Orchestrator” views the Container as “out of compliance” with user intent and takes steps to re-interpret the Container's Tags and manipulate the cloud to become “compliant” with user intent. In still another embodiment, the Tag is created by a user on a custom basis to describe attributes or business policies for the user's local cloud.

### BRIEF DESCRIPTION OF THE DRAWINGS

The structure and function of the invention can be best understood from the description herein in conjunction with the accompanying figures. The figures are not necessarily to scale, emphasis instead generally being placed upon illustrative principles. The figures are to be considered illustrative in all aspects and are not intended to limit the invention, the scope of which is defined only by the claims.

FIG. 1A is a highly schematic block diagram of an embodiment of a computation unit that is part of an embodiment of a cloud based virtual machine system.

FIG. 1B is a highly schematic block diagram of an embodiment of a cloud based virtual machine system.

FIG. 2 is a schematic diagram of a cloud computing resource management system that includes an orchestrator and other components according to an embodiment of the invention.

### DESCRIPTION OF A PREFERRED EMBODIMENT

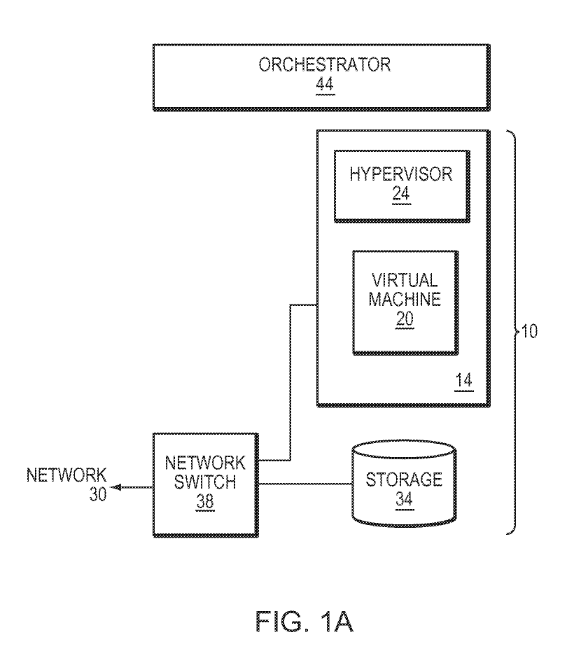

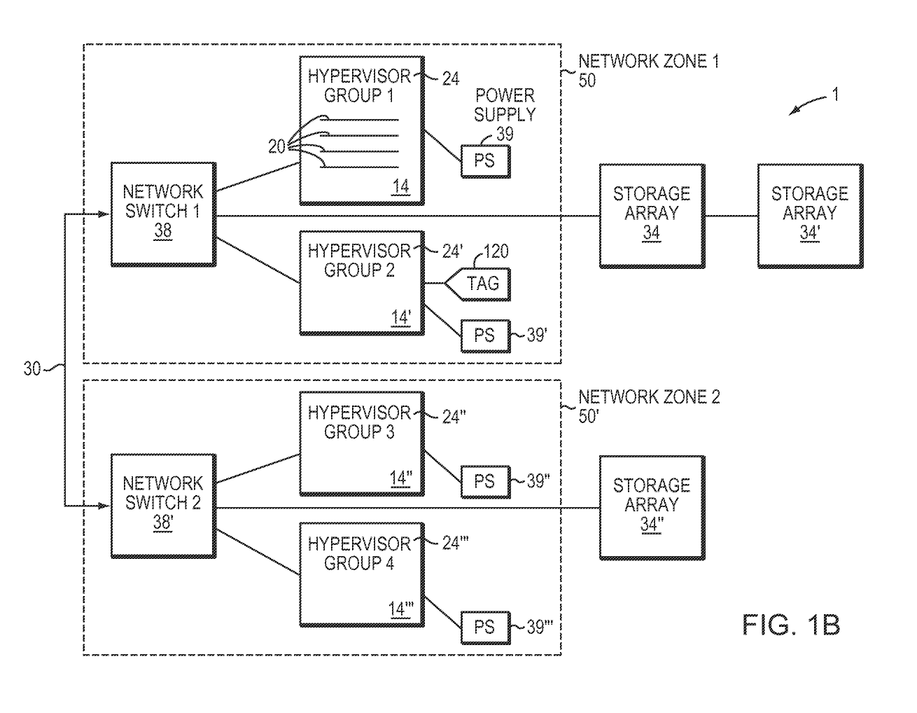

In brief overview and referring to FIG. 1A, one embodiment of a computation unit for a cloud based system constructed in accordance with the invention includes hardware and software components that are grouped together according to the needs of the user. The computation unit 10 includes a hardware server 14, hosting one or more virtual machines 20 under the control of a hypervisor 24 as described below. Each virtual machine 20 is in communication with a network 30 and one or more storage devices 34 through a network switch 38. The deployment and use of groups of computation units 10 is managed by a control system termed an Orchestrator 44 as described below.

In such a cloud environment, virtualization is frequently used to provide many users with the equivalent of a dedicated server and computation environment while actually using a single physical server 14 and other related hardware. Thus, virtualization is used to reduce the number of servers or other resources needed for a particular project or organization. Present day virtual machine computer systems utilize virtual machines 20 (VM) operating as guests within a physical host computer 14.

Each virtual machine 20 includes its own virtual operating system and operates under the control of a managing operating system or hypervisor 24 executing on the host physical machine 14. Each virtual machine 20 executes one or more applications and accesses physical data storage 34 and computer networks 30 as required by the applications. In addition, each virtual machine 20 may in turn act as the host computer system for another virtual machine. Various configurations of virtual machines can be used as part of a cloud configuration.

A benefit of such a cloud configuration is that virtual machines and their associated applications can be easily moved to various physical locations having the requisite hardware as the needs of the application change or as the hardware experiences failures. Further, multiple virtual machines may be configured as a group to execute one or more of the same programs or to execute multiple programs, which work together as an application. Typically, in the instance of a virtual machine acting as a critical component of the application, that particular virtual machine in the group will be referred to as requiring high availability, and instantiated with a primary or active virtual machine, and any remaining virtual machines associated with the application are the secondary or standby virtual machines.

If something goes wrong with the primary virtual machine, one of the secondary virtual machines can take over and assume the primary's role in the computing system. This redundancy allows the group of virtual machines to operate as a fault tolerant computing system. The primary virtual machine executes applications, receives and sends network data, and reads and writes to data storage while performing automated tasks or as a result of user-based interactions. In such a redundant system, the secondary virtual machines have the same capabilities as the primary virtual machine, but do not take over the relevant tasks and activities unless and until the primary virtual machine fails.

In more detail, referring to FIG. 1B, an embodiment of a data center 1 in which an embodiment of the invention may be used includes a plurality of physical processors (14, 14′, 14″, 14′″ generally 14) which may be referred to also as servers (server-1, server-2, . . . , server-m) typically, but not necessarily, located adjacent each other in a rack. Each server 14 includes an operating system, hypervisor 24 and one or more virtual operating systems (VM11, . . . , VMmn) (generally 20), each virtual operating system capable of executing one or more applications. Each of the servers 14 is in electrical communication with each of a plurality of network resources (network resource-1, . . . , network resource-j) (generally 30) and a plurality of storage devices (storage-1, . . . , storage-i) 34, 34′, 34″ (generally 34) through network switches 38, 38′ (generally 38). Each physical machine 14 typically will have its own power supply 39, 39′, 39″, 39′″ (generally 39).

The various components of the data center 1 can be configured as necessary to provide the correct environment for executing an application. As an example, in one embodiment, a virtual machine VM11 executing on server-1 and virtual machine VM21 executing on server-2 are both running the same application in a fault-tolerant configuration. In this exemplary configuration, there is redundant storage 34, 34′ (storage-1 and storage-2) and a network switch 38, 38′ (generally 38) (network resource-1, and network resource-j). As shown, the combination of VM11 and VM21, network resources-2 and network resources-j, storage-1 and storage-2, and the application comprise a fault tolerant system. Various components may be part of more than one system. For example, virtual machine VMm1 on server-m may be part of a system (System-m) that includes network resource-j and storage I, even though network resource-j is also a resource of a different system (System-j).

To make the various possible combinations of hardware and software, physical and virtual machines, and their locations and other attributes manageable to a user, the virtual machines that are required to perform a set of functions for a given user are defined as belonging to a “Container”. A Container in various embodiments also includes other virtual machines which may require alternative availability levels including those that are of lesser importance, and do not require secondary virtual machines. If an application does not require high availability, then the application and its corresponding virtual machine are referred to as a “Commodity”.

In one embodiment, a Container refers to a collection of hardware, software, and attributes within which some information technology function is performed, while in another context, a Container is a collection of descriptors (known as a Deployment Package) that describes the interrelationships among each component of a software application and their relationships to resources outside of the cloud, such as: Images, Volumes, Internal Network Interdependencies, External Network Interdependencies, and security requirements.

Generally, a software application and its deployment environment(s) form a logical Container. A given software application has a number of possible Deployment Packages representing valid hardware and software configurations for the application. The differences among Deployment Packages relate to availability/redundancy performance requirements, business rules, and behavioral characteristics.

As an example, in a valid Deployment Package, certain hardware and software may be necessary for a given software application to have access to a network. Such a valid Deployment Package would include an environment with a network connection. Further, as another example, a business rule can relate to Geographic Location. Thus, there may be a restriction on certain data in an application that requires that the data not leave the United States. In this case, a business rule is constructed which is “Geographic Data Restrictions”, with Tags United States, Canada, Mexico, etc. The Hypervisors would be tagged with their Geographic Location (United States, Canada, Mexico, etc.) and a restriction of “United States” would be placed in the Deployment Package, forcing all placements to remain within the Geography. A list of Deployment Packages is provided for each available application, termed a Catalog Application.

Each Deployment Package includes an associated Network Topology. The Network Topology is a description of the networking environment in which the application will live. A Network Topology can define multiple networks, routings between networks, and routings to and from locations external to the cloud. For each instance specified in the deployment package, there is a specification of the networks in the topology to which they connect, the external connections that are routed, and the internal connection interdependencies among instances in the same deployment package. For example, a Web Server might have a port to a network defined as External which is a connection (routing) to the external web. That same web server may also have a port to an internal network, so that it may pass on requests to internal VM's. Specification of internal connections allows the internal VM's to determine whether traffic from this web server is acceptable. The specification of internal and external connections in the deployment package drives automatic generation of security group (firewall) rules at deployment time.

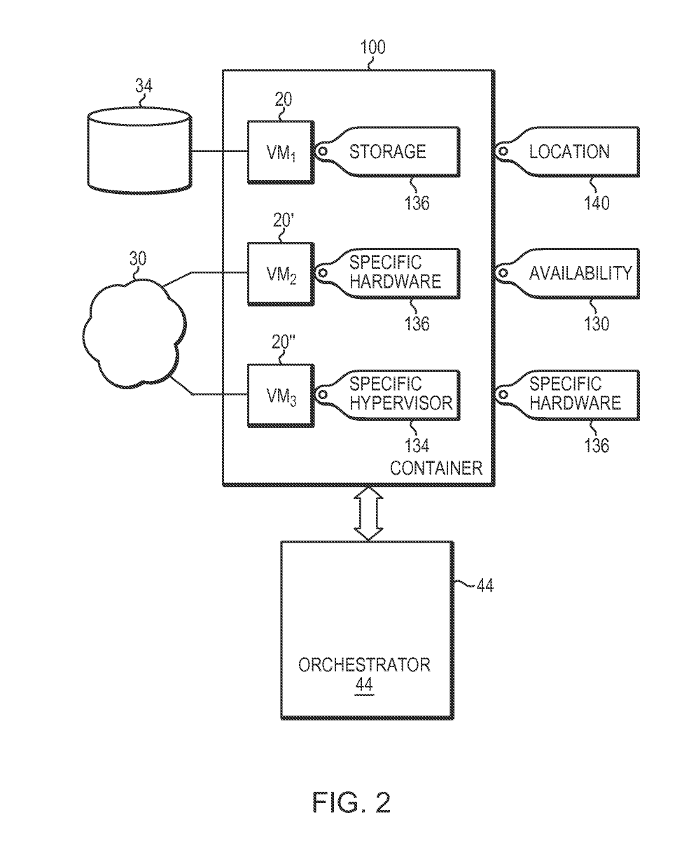

Referring also to FIG. 2, a typical Container 100 includes one or more virtual machines 20, 20′, 20″ that together provide the provisioning for a specific workload for a specific user. For example, one virtual machine 20 may act as a database server for the other virtual machines 20′, 20″ which provide website interfaces to customers who are ordering merchandise using the network. The database server 20 requires disk storage while the user interface virtual machines require access to the network 30.

The virtual machine 20 providing access to the database 34 is more important to the operation of the system than the virtual machines 20′, 20″ providing the user interface. This is because if an interface virtual machine 20′ fails, the network will redirect the user to another user interface machine 20″, but if the database server 20 fails, the system is not able to provide the required data for purchasing the merchandise. Thus, the database server virtual machine 20 should be designated as requiring higher availability than the interface server virtual machines 20′, 20″.

In order to help a user understand the hardware, software and attributes of the system, a label or “Tag” 120 (FIG. 1B) is assigned to each component in the user's system. Tags describe desired behaviors of the cloud resources such as: availability level (strategy to implement), performance level, types of hypervisors to consume, types of storage to consume, types of monitoring to utilize, physical location, and/or recovery model (desired behavior for failure recovery). Tags not only label the components of the system, but are used to change the actions of components.

Once an application is deployed, the various Tags may be manipulated to alter behaviors of the components of the application, either permanently or according to a schedule. For example, a requirement that a given Container be required to provide high availability for the computing resources that, at least partially, define the Container can be accomplished by assigning a High Availability Tag to the Container. If high availability is only required for a period of time, a user may schedule such a Tag to be changed in the future, altering the behavior of the application at that time. Upon a change to a Tag, either by user manipulation or scheduled change, a control system termed an “Orchestrator” views the Container as “out of compliance” with user intent and takes steps to re-interpret the Container's Tags and manipulate the cloud to become “compliant” with user intent. In still another embodiment, the Tag is created by a user on a custom basis to describe attributes or business policies for the user's local cloud.

The fact that all the virtual machines 20, 20′, 20″ (FIG. 2) occupy the same Container, along with the use of Tags, provides the system with a frame of reference to evaluate how the workload is affected by changes in the individual machines in contrast with a typical system that only looks at individual machine statistics. For example, without the computing resources being arranged and interrelated via a Container and/or one or more Tags, a program monitoring virtual machines 20, 20′, 20″ would note that the system was operating at 66% utilization if the database virtual machine 20 failed, because the other two virtual machines 20′, 20″ (of the three virtual machines) were still functioning. This completely disregards the fact that if the virtual machine 20 is the database server and fails, the system is operating at 0% utilization because the system is nonfunctional without the database server 20. Thus, by using a Container and Tags to interrelate computing resources, the Orchestrator has additional information about how the system is actually working. With this information, the system can take steps to migrate the virtual machine database server to another physical machine in order to preserve its availability.

In more detail, Tags contain business-specific information related to the workload. In one embodiment, Tags include application category, availability 130, performance 132, hypervisor type 134, storage type 136, recovery mode 138, and location 140. Considering these Tags separately:
Availability is the amount of desired “up-time” and is grouped into the categories of “Mission Critical” (where the virtual machines require fault tolerance/transaction protection and total duplication of network, power, etc.), “Business Critical” (Requiring High Availability and protection of written data, where a transaction may require being resent on failure), or “Commodity” (where the virtual machines are subject to the availability of the underlying infrastructure, and are not protected via software).
Hypervisor type means the type of hypervisor, for example VMWARE®, associated with the virtual machine. A Hypervisor type is important because certain images are only able to run on specific hypervisors. For example, a “.vmdk” image that is specially formatted to run on a VMWARE® Hypervisor would not run on a XenServer® Hypervisor because each requires a different file format. Some images, but not all, are able to be instantiated on multiple hypervisor types.
Storage type describes the type of storage, such as solid state disk, long term, write-once, or any other behavioral characteristic required by the business or by the application.
Recovery mode means the option to utilize an ephemeral (reset on reboot) or a stateful virtual machine.
Location means the physical location of the hardware on which the application is to be executed.
Hypervisor Group is a group of hypervisors that would potentially fail together. The most obvious example of this is a group of hypervisors that all share the same power supply. Thus, the Hypervisor Group is describing the fault zones or groups of hypervisors.
Redundancy Group: When two or more VM's, for example Web Servers or replicated database nodes, are determined to be redundant with one another, they are assigned to the same redundancy group. When workload placement is performed, redundant VM's are placed in different fault zones by being deployed to hypervisors in different hypervisor groups

In other embodiments, additional Tags may be created by the user to provide a descriptor to aid the user in identifying the Container or application. For example, if all of the elements of a financial transaction system need to be PCI compliant, need to run on an SSD storage device, need to be allocated to a high availability computing environment, or all three of the forgoing, Tags and Containers can be used to properly identify all of these requirements and others as a function of the needs of the organization.

Further, Tags exist as a hierarchy in which more specific Tags take precedence over less specific Tags when the components of the Container are examined by the Orchestrator 44. For example, if the Container 100 has an unspecified availability but a virtual machine 20 in the Container 100 is specified as High Availability, then the virtual machine 20 takes on an availability Tag as High Availability with respect to that virtual Container 100. Each virtual machine in a Container may have the same or different Tags associated with it. Instances within a Container are currently assigned within a “network topology”. This network topology can cross networks and subnets and can cross Availability Zones. Thus, one machine could have one security policy and a second machine could have a different security policy associated with it.

The monitoring of the Container and the virtual machines, and the movement or reconfiguration of the Container or virtual machines, is provided by the rules engine of the Orchestrator 44. The Orchestrator 44 rules system, as discussed below, controls the functioning and provisioning of the virtual systems in the physical servers. To do this, the Orchestrator 44 makes use of Tags that are associated with the components of the Container 100, such as the virtual machines 20 and the Container 100 itself.

The rules of the Orchestrator 44 utilize the Tags to determine how the various systems should function. For example, the Orchestrator 44 can change the location of the Container 100 to an equivalent but different physical location if the hardware in the first location begins to fail and the applications running are designated as High Availability. In this case, the Orchestrator 44 knows what locations have the proper hardware and availability to simply move the Container, and hence all of its components, to the new location by setting the location Tag to the new location.

The capability to move Containers between environments is important for Disaster Recovery (DR). In DR, the system recovers from outages due to varying levels of infrastructure loss. The Orchestrator 44, in the case of hardware failure, can use the Tags to change the locations of the Containers. The Orchestrator in various embodiments produces a report for the user calculating the existence of various hypothetical failures and the success in moving Containers to various alternate locations. To accomplish this, upon the deployment of an application, a file is created which contains enough information to replicate the initial Application deployment from existing images. Changes made to the application after initial deployment are maintained in a history file by an agent that writes all such system changes to disk.

In addition to DR and hardware failure remediation, the Orchestrator also is used for workload placement on hypervisors and load balancing. To perform workload placement, the Orchestrator 1) gathers all potentially useful hypervisors and 2) filters the resulting list using Tags, 3) scores the remaining hypervisors based on capacity and 4) compares the resulting list to suggest a best hypervisor.

In more detail, the Orchestrator first considers all hypervisors of which it is aware and removes from the list any hypervisors that are not enabled, are not managed by the Orchestrator, are being evacuated due to facility issues or which are “blacklisted” as having too high a workload. “Up”, with respect to a hypervisor, refers to the physical hypervisor being in a ‘running’ state. Conversely, “down” refers to a hypervisor that is not in a running state. “Enabled” means that the hypervisor may be utilized, while “Not Enabled” means that regardless of the programmatic state of running or not running, the hypervisor cannot be used. Once the potentially available hypervisors have been selected, these hypervisors are filtered to select those that are capable of accepting the Containers to be placed.

The initial filtering is performed by matching the value of the Container Tag with the value of the hypervisor Tag. A Tag is typically matched as a Boolean value: true/false or yes/no. For example, one filter is the availability filter. With this filter enabled, a Container with “mission critical” applications cannot be placed on a hypervisor designated as Commodity, but a Container designated as holding a Commodity application can be placed on a hypervisor designated as Mission Critical. The degree of match within each category is determined by a numerical value based on the percent match (for example: exact match, best idea, non match), and then the total across all of the tag categories are summed with the highest resulting score being designated as best match.

In order to accommodate the fact that Tag values may not match perfectly, the Orchestrator uses placement rules to make imperfect matches. For example, a placement rule might say that placing a Container designated as a Commodity on a hypervisor designated as Business Critical is permitted, but has a score of 50, while placing that Commodity Container on a hypervisor designated as Mission Critical is also permitted but has a score of 0. This rule will tend to place the commodity workload on Business Critical hypervisors, although this is an imperfect choice.

In addition to the availability filter, other filter embodiments include:

Recovery Mode—This filter filters on whether the hypervisor has shared storage for applications that need shared storage;

Hypervisor type—This filter filters on the type of hypervisor being considered, for example VMWARE®;

Location—This filter determines if the hypervisor exists in the desired geographic location; and

Capacity filter—Determines whether the workload capacity matches the capacity of the hypervisor. This is done to avoid placing a low capacity workload on a high capacity hypervisor (e.g. 8 CPU 16 GB workload on an 8 CPU 192 GB hypervisor). To calculate capacity in this filter, the Orchestrator uses four variables associated with the hypervisor: CPU utilization, memory utilization or availability; storage consumption or free space available; and I/O traffic to determine workload capacity.

In addition, the Orchestrator considers Utilization Percent, which is the Hypervisor free space minus the utilization of the new application divided by the total space; and Weighting results, which is a weighting value applied to each filter according to perceived importance to a user. A weighting value is a user-settable variable that allows the user to be able to order the categories and determine how important they are to the user's business. The weights are then set by the system based on the individual user's business preferences.

Upon completion of this filtering, the calculation returns one or more of: an ordered list of candidate hypervisors; a group of scores associated with each hypervisor; no hypervisor located or recommended hypervisor.

Some portions of the detailed description are presented in terms of algorithms and symbolic representations of operations on data bits within a computer memory. These algorithmic descriptions and representations can be used by those skilled in the computer and software related fields.

The algorithms and displays presented herein are not inherently related to any particular computer or other apparatus, provided the computer or other apparatus is capable of executing a rules engine. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

What is claimed is:

1. A method of provisioning a computer application in a cloud environment having hardware, the method comprising the steps of:
providing the computer application;
defining processing requirements of the computer application;
defining storage requirements of the computer application;
defining network requirements of the computer application;
defining policies for the computer application;
defining a Container comprising the computer application, the processing requirements of the computer application, the storage requirements of the computer application, the network requirements of the computer application, the policies for the computer application; and
providing an Orchestrator able to access the Container;
automatically selecting, by the Orchestrator, cloud hardware in response to the requirements and policies of the computer application.

2. The method of claim 1 wherein the Container is associated with a Tag and wherein the Tag includes at least one of: application category, availability, performance, hypervisor type, storage type, recovery mode, business policies and location.

3. The method of claim 1 wherein the components of the Container are each associated with one or more Tags.

4. The method of claim 2 wherein the Tag is created by a user.

5. The method of claim 1 further comprising the step of defining a Deployment Package wherein the Deployment Package comprises a set of descriptors describing the interrelationship among the software application and resources outside the cloud.

6. The method of claim 5 wherein the Deployment Package is associated with a network topology, the network topology defining multiple networks, routings between networks, and routings to and from locations external to the cloud.

7. The method of claim 6 wherein the Deployment Package causes the generation of security rules at a time of deployment in response to the network topology.

8. The method of claim 1 wherein the Orchestrator is a rules engine that utilizes Tags to determine how the hardware and software should function.

9. A computer system comprising:
a plurality of network zones, each network zone of the plurality of network zones comprising:
a plurality of hypervisor groups, each hypervisor group of the plurality of hypervisor groups comprising:
a plurality of physical processors, each physical processor of the plurality of physical processors comprising:
a hypervisor;
a plurality of virtual machines;
a power supply;
a storage array; and
a network switch in communication with each hypervisor group of the network zone, the storage array of the network zone, and at least one network switch of another network zone;
wherein each hypervisor group comprises a plurality of tags.

10. The computer system of claim 9 wherein the tags are selected from the group comprising: specific hardware, storage, specific hypervisor, location, and availability.

11. The computer system of claim 9 wherein the system further comprises an Orchestrator.

12. The computer system of claim 9 further comprising:
a computer application defining processing requirements of the computer application, storage requirements of the computer application, network requirements of the computer application and policies for the computer application.

13. The computer system of claim 12 further comprising:
a Container comprising the computer application, the processing requirements of the computer application, the storage requirements of the computer application, the network requirements of the computer application, and the policies for the computer application.

14. The computer system of claim 13 further comprising:
an Orchestrator, the Orchestrator able to access the Container; and
automatically selecting, by the Orchestrator, cloud hardware in response to the requirements and policies of the computer application.

15. The computer system of claim 14 wherein the Container is associated with a Tag and wherein the Tag includes at least one of: application category, availability, performance, hypervisor type, storage type, recovery mode, business policies and location.

16. The computer system of claim 15 wherein the Orchestrator selects cloud hardware in response to the Container Tag.

17. The computer system of claim 16 wherein the Orchestrator generates a match score in response to the cloud hardware and the Container Tag and selects cloud hardware in response to the highest match score.

18. The computer system of claim 17 wherein the match score comprises availability, Recovery Mode, Hypervisor Type, Location, Capacity, Utilization Percent and Weighting.

19. The computer system of claim 18 wherein availability comprises up-time.

20. The computer system of claim 19 wherein availability comprises: mission critical, business critical or commodity designations.

21. The computer system of claim 16 wherein the Orchestrator moves the Container to another hardware location in the event of hardware failure in the current location 22.

22. The computer system of claim 21 wherein the Orchestrator moves the Container by resetting the location entry in the Container Tag.
